(19) United States
(12) Patent Application Publication
(10) Pub. No.: US 2009/0089165 A1
(43) Pub. Date: Apr. 2, 2009

(54) System and method for a telephony upgrade credit

(75) Inventor: Jeffrey M. Sweeney, Olathe, KS (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: Embarq Holdings Company, LLC

(21) Appl. No.: 11/904,699

(22) Filed: Sep. 28, 2007

(51) Int. Cl. G06Q 30/00

(52) U.S. Cl. 705/14; 705/34

(57) ABSTRACT

A system and method for a feature credit. A feature credit for a user is determined in response to one or more telephony services being utilized by the user. A feature credit balance is adjusted in response to determining the feature credit. The feature credit is redeemed based on user input to provide the user a redemption service.

### BACKGROUND

The use and development of communications has grown nearly exponentially in recent years. The growth is fueled by larger wired and wireless networks with more reliable protocols and better communications hardware available to service providers and consumers. Based on these drastic improvements, users have come to expect upgrades, enhanced features and services, and more advanced communications devices that were unavailable only a few years ago. In many cases, users are enticed to sign up for a communications service plan or extended service agreement based on offers of free communications devices, low initial rates, expanded services programs, or rebates. For example, in order to receive a rebate for the up-front cost of a modem, the user may be required to sign an Internet service contract for two years.

Many times users feel that they are offered a new device or rebates strictly to persuade them to maintain or renew their current service contract. In some instances, users look for different communications service providers offering better devices, features, and service out of resentment or frustration. Even high-priority customers that purchase costly communications services or large scale service contracts may experience such frustration. For example, a small business that purchases wireless and data service for fifty cellular phones and Voice over Internet Protocol (VoIP) telephones may be treated the same as a single wireless consumer. The result is that many customers “churn” or continuously change communications service providers in order to qualify for the best devices, features, and services costs. In many cases, communications service providers lose high-value customers as they move on to the newest services offered by a different communications service provider. As a result, encouraging communications customers to remain with a communications service provider has become increasingly important.

### SUMMARY

One embodiment provides a system and method for a feature credit. The feature credit for a user may be determined in response to one or more telephony services being utilized by the user. A feature credit balance may be adjusted in response to determining the feature credit. The feature credit may be redeemed based on user input to provide the user a redemption service.

Another embodiment includes a billing system. The billing system may include a server configured to determine a telephony upgrade credit issued to a user in response to an elapsed period of service. The billing system may further include a database in communication with the server. The database may be configured to store the telephony upgrade credit for access by the server. The server may further receive user input from a user through a graphical user interface to redeem the telephony upgrade credit for devices, services, or features available through a communication network.

Yet another embodiment includes a billing system. The billing system may include a processor for executing a set of instructions. The billing system may further include a memory configured to store the set of instructions. The set of instructions may determine a new telephony upgrade credit to issue to a user in response to an elapsed period of service, sum the new telephony upgrade credit with a balance of a pre-existing telephony upgrade credit to generate a total, display the new telephony upgrade credit and the total to the user, and receive user input for redeeming the total to receive redemption services for a specified time period.

### BRIEF DESCRIPTION OF THE DRAWINGS

Illustrative embodiments of the present invention are described in detail below with reference to the attached drawing figures, which are incorporated by reference herein and wherein:

FIG. 1 is a pictorial representation of one embodiment of a communications billing environment in accordance with an illustrative embodiment;

FIG. 2 is a block diagram of a billing system in accordance with an illustrative embodiment;

FIG. 3 is a flowchart of a process for accruing a telephony upgrade credit in accordance with an illustrative embodiment;

FIG. 4 is a flowchart of a process for redeeming a telephony upgrade credit in accordance with an illustrative embodiment; and

FIG. 5 is a graphical user interface for telephony upgrade credits in accordance with an illustrative embodiment.

### DETAILED DESCRIPTION OF THE DRAWINGS

Illustrative embodiments of the present invention provide a system and method for a telephony upgrade credit. In one embodiment, a user, organization, or business (hereinafter referred to as a “user”) accrues a credit for a specified time period that may be used to acquire new communication devices, services, features, rebates, or credits. The credit may be referred to as a feature, communications, telephony, or upgrade credit. The telephony upgrade credit may be based on the value of the user. The user value may be calculated based on the amount and types of services purchased by the user through a communications service provider. For example, the user may be a business that subscribes the wireless, Ethernet, and VoIP service through the communications service provider and is awarded a substantial telephony upgrade credit each month because of loyalty and overall value to the communications service provider. The telephony upgrade credit may be displayed to the user in a monthly bill, invoice, or electronically via a website or email.

As a result, the user may determine at any time how the credit has increased and view the current total credit. The communications service provider may also give bonus credits based on upgrades or at strategic times in order to reward and motivate the user to maintain the communications service(s). The telephony upgrade credit may increase customer retention and provide an incentive to retain and expand communications services purchased by a customer from a communications service provider.

In one embodiment, the telephony upgrade credit is one example of a feature credit. The feature credit, which may encompass the telephony upgrade credit and may be redeemed to purchase communication devices and accessories, ring tones, music, movies, streamable content, new features, expanded services, third-party products, as well as receive discounts, rebates, and credits across a range of telephony services (herein referred to as the “redemption services”). The feature credit may be determined, accrued, summed, tracked, and otherwise reported by the systems and methods herein described.

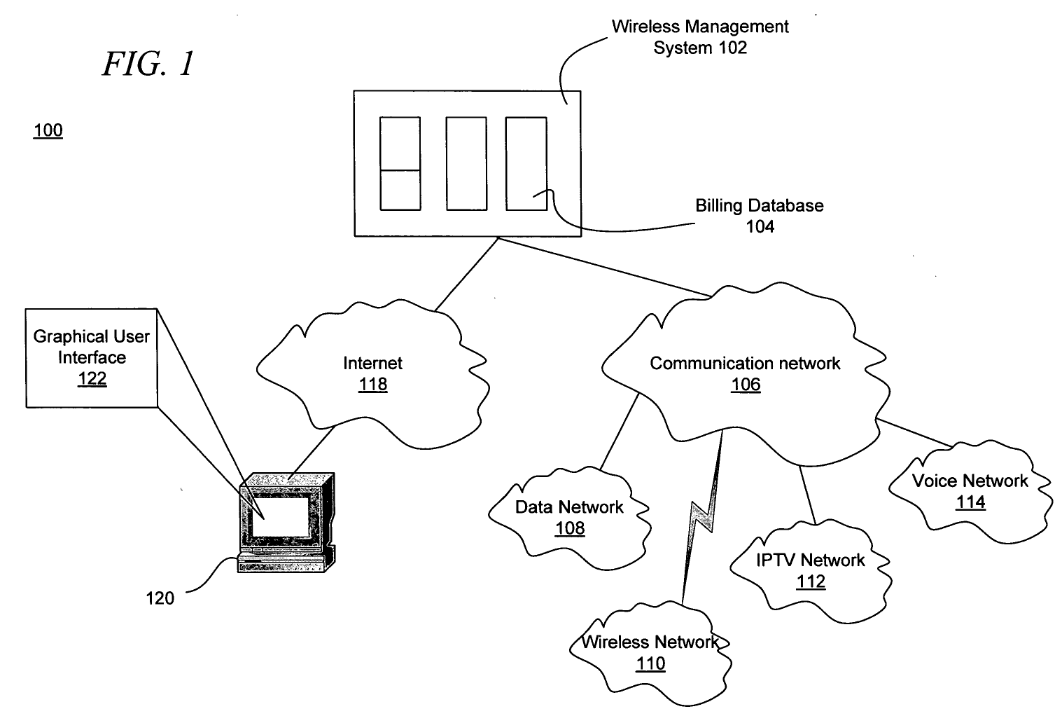

FIG. 1 is a pictorial representation of one embodiment of a communication billing environment in accordance with an illustrative embodiment. The communication billing environment 100 of FIG. 1 may include various components including a wireless communication management system 102, a billing database 104, a communication network 106 which may encompass a data network 108, a wireless network 110, an Internet Protocol television (IPTV) network 112, a voice network 114, Internet 118, a client 120, and a graphical user interface (GUI) 122.

The communication management system 102 may be a combination of hardware and software for managing the communication network 106. The communication management system 102 may be or include one or more intelligent network devices, servers, and components. For example, the communication management system 102 may be an advanced intelligent network device that may quickly and economically modify the billing configuration and preferences of the billing database 104. The communication management system 102 and the communication network 106 may include any number of devices including mobile switching centers (MSC), exchanges, databases, home locator records, virtual locator records, wireless transceivers, servers, switches, routers, and other similar devices, connections, and components.

The billing database 104 may be used to track record, upgrade, and display a telephony upgrade credit to a user. In one embodiment, the client 120 may review and update information and preferences stored in the billing database 104. The telephony upgrade credit, communication upgrade credit, or upgrade credit as used herein is a credit given per specified time period that may be used or redeemed to purchase the redemption services. For example, the telephony upgrade credit may be allotted to a user each month and redeemed to buy a telephone enabled for WiFi voice and data communication, as well as cellular service. Alternatively, the telephony upgrade credit may be used to upgrade services or other features, such as expanded bandwidth for a data connection through the data network 108. In another example, the telephony upgrade credit may be used to purchase unlimited text messaging for a month, year, or other specified trial or time period.

In one embodiment, the billing database 104 or communication management system 102 may include a transactional module or transactional services for redeeming the telephony upgrade credit to purchase the redemption services. The transactional server may be used to process a payment from the user if the telephony upgrade credit is insufficient to cover the cost of the redemption services, but the user wants to purchase the redemption services anyway. For example, the transactional server may be able to bill a user's credit card or communications service account for expanded dialing features available through the voice network 114.

The billing database 104 may control invoicing, billing, payment, and record keeping of services provided through the communication network 106. In one embodiment, the billing database 104 may be an integrated software module within the communication management system 102. In another embodiment, the billing database 104 may be a storage database or server linked with the communication management system 102. Alternatively, the billing database 104 may be externally linked with the communication management system 102.

The communication management system 102 may perform administrative and automatic changes and configurations for the communication network 106 by acting as a gateway, proxy, interface, or control system. The communication network 106 controls performance and operation of the data network 108, the wireless network 110, the IPTV network 112, and the voice network 114. The wireless network 110 may operate any number of wireless devices including cellular phones, a Blackberry®, personal digital assistants (PDA), laptops, evolution data optimized (EDO) or broadband data cards, and other wireless communications or computing devices.

The wireless network 110 may use any number of wireless communication protocols including, but not limited to, code division multiple access (CDMA), time division multiple access (TDMA), global system for mobile (GSM) communications, WiFi, and WiMAX. The wireless management system 102 and the communication network 106 may communicate signals, data, and information with other wireless networks, publicly-switched networks, data networks such as the Internet 118, and other public and private communications networks.

As previously described, the communication network may encompass the data network 108, wireless network 110, IPTV network 112, and voice network 114 and the hardware, software, protocols, standards, services, and features that correspond to each. As with the wireless network 110, the digital network 108 enables various forms of data communications. For example, the data communications may cover the hardware, software, and other elements and services to receive data communications including, but not limited to, DSL, frame relay, ATM, Ethernet, dedicated connections and Internet access, virtual private networks (VPN), and other similar data services. Similarly, the IPTV network 112 may allow users to receive IPTV services. The voice network 114 may include plain old telephone service (POTS) and VoIP telephone service. The voice network 114 may include calling plans, features, and services for users. Alternatively, the VoIP service and IPTV network 112 may be integrated with the data network 108.

The Internet 118 may be any type of data network connecting the wireless management system 102 and the client 120 using a fiber optic connection, T1, cable, DSL, satellite, high-speed trunk, or other wired or wireless connections. Aspects of different embodiments may be performed by the communication management system 102, and particularly the billing database 104, based on user feedback and communications with other data and/or communications systems.

Any number of communications protocols may be used to exchange data between the client 120 and the communication management system 102 and the networks encompassed within the communication network 106. In one embodiment, the communications protocol is a common channel signaling system 7 (SS7). SS7 refers to the exchange of information between communications networks and components required to provide and maintain service. The SS7 protocol is used by broadband networks to establish connections between switches and other devices in order to perform call-establishment, billing, routing, and information exchange functions of the wireless network 106. The communications protocol may also be based on transmission control protocol (TCP), Internet protocol (IP), or other commonly-used communications protocols and standards.

The client 120 may be a computing device suitable for displaying the GUI 122 to the user. For example, the client 120 may be a personal computer and the GUI 122 may be integrated or accessible from an application such as a web browser. In another embodiment, the GUI 122 may be a secure client executed by a data processing system to perform the features and tasks described herein. Alternatively, the GUI 122 may be part of a website provided by the communication management system 102 to allow the user to set telephony upgrade credit preferences, perform transactions, and view telephony upgrade credit activity.

The communication management system 102 may include a host application for managing communication with one or more remote clients. A user may be required to provide a secure identifier, such as a user name, password, or other authentication code or hardware interface that verifies the user is authorized to make changes within the billing database before the client 120 is granted access to all or a portion of the billing database 104. The authentication information may be used to establish a secure connection between the client 120 and the communication management system 102. The secure connection may be a virtual private network tunnel, an encrypted connection, firewall, or other form of secured communications link.

The GUI 122 may be configured to both display and receive information from the user. The GUI 122 may include any number of fields, buttons, icons, and other interfacing elements for display content and receiving user input and selections. In particular, the GUI 122 may display the transaction history for receiving and redeeming telephony upgrade credits for the user's account. The GUI 122 may allow the user to view available redemption services and the credits required to purchase them. For example, if the price or cost of the redemption service in credits exceeds the users available telephony upgrade credit total, the user may be shown an amount of credits required to immediately purchase the redemption service, the amount of credits the user lacks, and how long it may take the user to acquire the amount of credits required to purchase the specified redemption service.

In another embodiment, the user may access the GUI 122 to transfer credits. For example, the user may be able to transfer credits to another individual by entering an identifier such as phone number or email address. In one embodiment, one user may be an administrator for other users under a single service contract. For example, a family or business that purchases multiple services may receive credits for each profile registered under the account. The credits may be transferred to different profiles by the account administrator. As a result, credits may be pooled or otherwise utilized as an organizational award or for other purposes. For example, an employee that shows an exemplary work ethic may be rewarded by an administrator of the business by receiving all of the credits for the business account in order to redeem the credits for a wireless device of their choice.

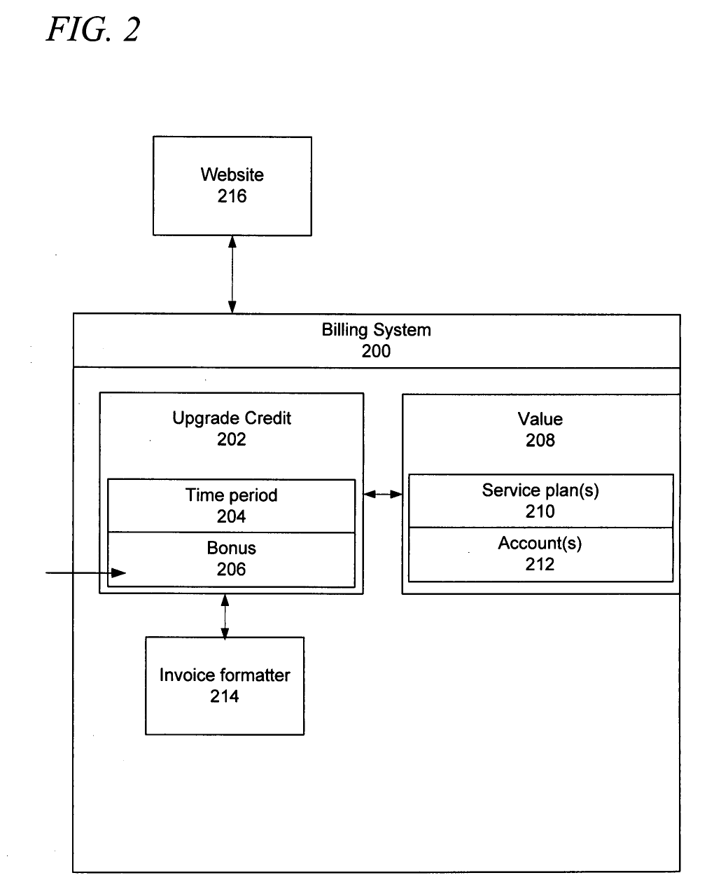

FIG. 2 is a block diagram of a billing system in accordance with an illustrative embodiment. The billing system 200 may include various hardware or software elements. In one embodiment, the billing system includes software modules such as an upgrade credit 202, a time period 204, a bonus 206, a value 208, a service plan 210, an account 212, and an invoice formatter 214. The billing system 200 is a particular implementation of the billing database of FIG. 1.

FIG. 2 may further include a website 216. The website 216 is an example of a particular implementation of the GUI 122 of FIG. 1. The website 216 may be used by customers/users and employees of the communications service provider to enter and receive information from the billing system 200. The billing system 200 may stream data or website content that may be displayed to the user in a display program such as a web browser or other graphical interface.

The billing system 200 may include a processor or processing element and memory for executing programs, modules, or instructions as shown in the block format of FIG. 2. The upgrade credit 202 tracks and sums the telephony upgrade credit based on the time period 204 and bonus 206. The time period 204 is used for incrementing the telephony upgrade credit may be specified by a policy or rule of the communications service provider. For example, the time period may be daily, weekly, bi-weekly, monthly, or bimonthly based on invoicing parameters used by the communications service provider or on user preferences. The communications service provider may set an individualized telephony upgrade credit that is incremented or tracked for each time period 204.

The bonus 206 may be a bonus or retention credit that is added to the running telephony upgrade credit based on manual input or specified criteria. The bonus 206 may add a credit at times that have been statistically linked to customers seeking out other communications service providers or otherwise cancelling or reducing services. The bonus 206 may also be linked to competitive pressures from other communications service providers. For example, if another communications service provider generates an offer or promotion that may potentially entice users to switch services, the bonus 206 may be generated to further persuade the users to remain with the communications service provider.

Alternatively, the bonus 206 may receive manual input from a customer service representative or other employee of the communications service provider. For example, based on a conversation in which the user expressed frustration with some aspect of the communications service, a customer service representative may be authorized to provide a retention credit that is added to the bonus 206. In one embodiment, the bonus 206 may be programmed to generate a seasonal, service anniversary, holiday, or date specific bonus credit. The bonus 206 may generate seasonal credits for holidays, birthdays, or other events. For example, the bonus 206 may generate a credit for the yearly anniversary date the user first signed up to be a customer with the communications service provider. In another example, the bonus may generate a theme-based credit for Christmas, Hanukkah, Halloween, the Fourth of July, or other cultural, social, and religious holidays that may be celebrated by customers.

Alternatively, the bonus 206 may generate credits for time periods during which the user may buy other users' communication devices or additional service plans as gifts. In one embodiment, the bonus 206 may be generated based on a user profile, selections, or feedback to properly reflect the user's personality and beliefs. In one embodiment, the bonus 206 may not be linked with the value 208 as a result; the bonus 206 may be incremented regardless of the services or products purchased by the user.

The addition of the bonus credits may be accompanied by an electronic or physical message thanking the user for being a valued customer and informing the user of the bonus credit. The message may also specify redemption services that the user qualifies to purchase or may soon qualify to purchase with the telephony upgrade credit. In one embodiment, the redemption of the telephony upgrade credit may be linked with a user extending a service contract or signing a new service contract in order to ensure that the user will remain with the communications service provider after using the telephony upgrade credit.

In one embodiment, the user may also receive a bonus credit for referring other potential customers. The bonus credit for making a referral may have multiple aspects. For example, the user may receive an initial credit for providing five names and contact information for those individuals. The user may additionally receive a sign-up credit for each referenced individual that signs up for a service through the communications service provider.

The value 208 may determine if the telephony upgrade credit is based on an intrinsic value of the user. Most communications service plans may include policies and rules that require all parties receive equal access to available services. The value may determine the telephony upgrade credit based on the revenue provided to the communications service provider. In one embodiment, the value 208 determinations may be made based on service plan 210 and account 212.

The service plan 210 may specify the services subscribed to by the user and the dollar value or profits generated from those services. For example, a user that pays for cellular, data, and text communications plans may be given a higher telephony upgrade credit per month than a user that subscribes only to cellular service. The service plan 210 may include services provided by a communications service provider that are not wireless services, such as cable, wired Internet, satellite, DSL, or other similar services. For example, a user that purchases a bundle of services at a higher cost may receive an increased telephony upgrade credit.

The account 212 may specify how many different accounts the user has or may supervise. In one example, the user may have both business and personal accounts. As a result, the user may be given an increased telephony upgrade credit over a different user that subscribes only to a paging service. In another example, the user may be a president, supervisor, chief technology officer, secretary, or other individual that manages or supervises a number of accounts. As a result, the supervising user may be given a large telephony upgrade credit to provide the user with more incentive to retain all of the service plans 210 and accounts 212. Additionally, the user may use the greater apportionment of telephony upgrade credits to purchase and test new communication devices, features, and services for potential roll-out to the other accounts managed by the user. For example, the user may purchase push-to-talk functionality for all users within a test group to determine whether the increased functionality would further enhance the user's business. As previously described, the telephony credits may also be used for incentive or rewards purposes and transferred to one or more individuals.

The upgrade credit 202 and value 208 software modules may also use other factors, parameters, rules, and administrative input to generate the telephony upgrade credit and the bonus 206. For example, if the user has consistently paid on time, the upgrade credit 202 may increase the monthly telephony upgrade credit. In another example, the user may be allotted additional telephony upgrade credits for recommending other users to sign up for services offered by the communications service provider. Further, the user may also receive an increased monthly telephony upgrade credit by signing up or redeeming service offers, such as for VoIP service and voice messaging.

In one embodiment, a base credit for each year or service term may be specified for each user. The base credit may be prorated over the time period 204 and allotted by the upgrade credit as determined by the prorated value. The base credit may be further incremented based on the value 208, service plan 210, and account 212. The term of the communication contract may also be set to vary based on the type of communication device that the user may want to purchase with the telephony upgrade credit.

In another embodiment, the credits may be apportioned based on the value 208, and more particularly, a percentage of the monthly payments received from the user. The percentage may be set by the communications service provider based on the value 208 and anticipated credits the user may receive. In one example, the user may receive a credit equivalent to 5% of monthly payments. As a result, by paying a monthly bill of eighty dollars, the user may receive four credits. In another embodiment, the upgrade credit 202 may specify value thresholds or levels and credits associated with each threshold or level. For example, users that pays approximately $0-49 a month may be given five credits a month, whereas user that pay approximately $49.01-99 a month may be given nine credits a month. Levels may be set for all applicable billing amounts as received by the communications service provider. Additionally, the threshold values or levels may be specified for dollar increments, such as every ten dollars billed to the user. The communications service provider may display charts, tables, or databases that detail how the upgrade credit 202 is allocated to each user.

In another embodiment, the upgrade credit 202 may be generated based on conserved or retained resources. For example, a user that keeps bandwidth, text messaging, long distance, or wireless minutes below specified thresholds may receive a credit. In one embodiment, the credit may be equivalent to the difference between two different service plans. For example, if the user has only used 200 minutes of wireless calling, but has paid for 400 minutes, the user may receive 20 credits as a form of reverse compensation. The thresholds and usage criteria may be set by the communications service provider based on loads, available resources, and network statistics. For example, the communications service provider may have a shortage of wireless bandwidth and, as a result, may reward users that do not make calls during peak hours by expanding the upgrade credit 202 provided to the user. The thresholds and criteria may be communicated to the user in order to provide an incentive to facilitate the needs and goals of the communications service provider. In another example, users that power down a set-top box to preserve bandwidth used by their IPTV service may be given a monthly incentive based on the inactivity of the set-top box. By providing the upgrade credit 202 based on specified thresholds and criteria, the communications service provider may be able to provide better quality of service and satisfaction to all communication users. The utilization thresholds or levels that may qualify the user to receive the upgrade credit 202 based on conserving resources may be further specified on an invoice, website, or other information content.

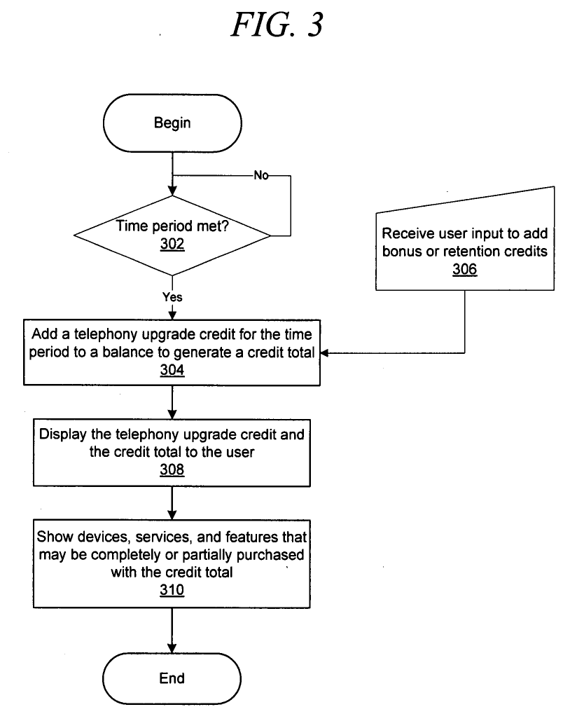

FIG. 3 is a flowchart of a process for accruing a telephony upgrade credit in accordance with an illustrative embodiment. The process of FIG. 3 may be implemented by a billing database, billing modules of a MSC, or other billing or communication management control system. The process may begin by determining whether a time period is met (step 302). The time period may be the regular billing or invoice period for a communications service provider. In one embodiment, the time period is a month. The beginning and ending of the time period may be established for all users or may depend on when the user initially signed up for communications service. The time period may also be a day, week bi-weekly period, bi-monthly period, year, or anytime frame suitable for billing a communication user or providing billing and usage information. An arbitrary start and time period may be selected in the event the user receives multiple service invoices at different times. In another example, the time period may be linked with a primary service received by the user.

Next, the billing system adds a telephony upgrade credit for the time period to a balance to generate a credit total (step 304). The telephony upgrade credit may be the credit apportioned for each specified time period. The telephony upgrade credit may have been set or determined at the time the user signed a service contract. The telephony upgrade credit may also be determined based on a value or level assigned to the user. For example, the value levels may include low, medium, and high value users for determining the telephony upgrade credit apportioned each month. The communications service provider may use any number of criteria to classify users or may not use value levels or classifications at all. The value may be specified based on factors which may include revenue generated for the communications service provider by the user, service plan(s), and account(s) as previously described. The telephony upgrade credit allotted to the user may vary each month or be based on any number of factors as herein described.

The telephony upgrade credit may be one or more credits. The one or more credits may be attributable to any number of services or products that are purchased by the user from the communications service provider. The telephony upgrade credit may be added as an integrated unit or separately to generate the balance.

The balance may be the running total or summed total of the previously-accrued telephony upgrade credits. The total may be calculated by adding the previous balance with the telephony upgrade credit for the month or other specified time period.

At anytime, the billing system may receive user input to add bonus or retention credits (step 306). The bonus or retention credits may be added to the telephony upgrade credit or directly to the balance. The bonus or retention credits may be manually submitted or generated based on pre-defined criteria. The pre-defined criteria may be information or statistics regarding the likelihood of losing the user as a customer. For example, a communications service provider may be statistically more likely to lose customers at eighteen months into a two-year contract. As a result, the billing system may generate or receive user input to add fifty credits as a bonus at the seventeen month mark. The billing system may be configured to process any number of automatic and manual credit updates.

The billing system adds a telephony upgrade credit for the time period to a balance to generate a credit total (step 304). As mentioned in step 306, the telephony upgrade credit may include the bonus or retention credits. Next, the billing system displays the telephony upgrade credit and the credit total to the user (step 308). The credit information of step 308 may be displayed in any number of ways. In one embodiment, the credit information may be displayed in a monthly billing invoice mailed to the user. Alternatively, the invoice may be saved in an electronic format and e-mailed or text messaged to the user. In yet another embodiment, the user may view the credit information of step 308 using a graphical user interface of a website or other electronic interface. For example, the website may be displayed to the user's personal computer by a server of the billing system.

The billing system may also show devices, services, and features that may be completely or partially purchased with the credit total with the process terminating thereafter (step 310). In one example, the credit total may have incremented to the point that the user may completely redeem the credits to obtain a specified redemption service. Alternatively, the total credits may be insufficient to obtain a redemption service. As a result in step 310, the user may be shown a purchase price or user cost that may be paid in conjunction with the redemption of the total credits to purchase the redemption service. For example, if a newly-released smart phone/PC is available for 400 credits, but the user only has 280 credits, the user may still be able to use the smart phone/PC if willing to pay the dollar equivalent of 120 credits which may be $60. Alternatively, the user may wish to purchase expanded bandwidth of 20 MB/s (instead of 10 MB/s already purchased) for 400 credits, but has only 380 credits, the user may still test the expanded bandwidth for the month if the user is willing to pay the dollar equivalent of 20 credits which may be $4. The dollar to credit value may be predetermined and specified by the communications service provider in order to allow the user to make the best redemption decisions.

In step 310, the user may also be shown the cost in credits and how long the user may need to wait before he/she has accrued the amount of credits necessary to purchase selected redemption services. The telephony upgrade credit of FIG. 3 may motivate communications users to retain communications service through a service provider based on the future redemption of credits and availability of credit information.

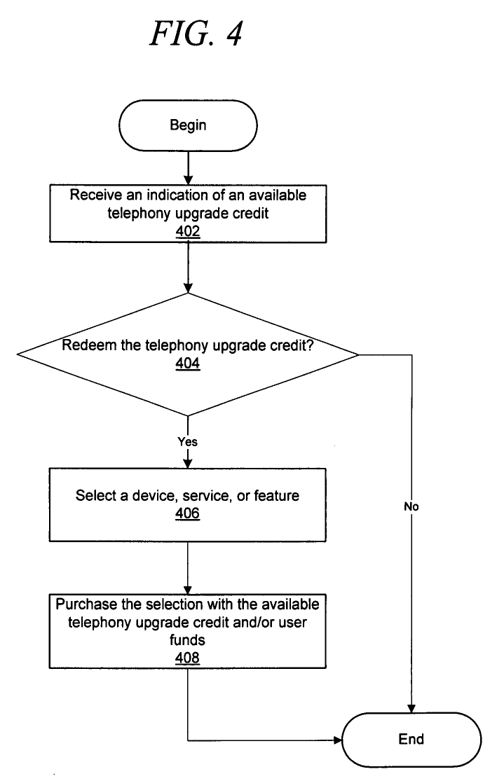

FIG. 4 is a flowchart of a process for redeeming a telephony upgrade credit in accordance with an illustrative embodiment. The process of FIG. 4 may be implemented by a user using a computing device such as a personal computer, laptop, PDA, wireless phone, media player, or other similar system or device. A website, graphical user interface, or other electronic interface may be used to display information and receive user input. The process begins with the user receiving an indication of an available telephony upgrade credit (step 402). The indication may be received in a paper invoice, email, text message, or through a graphical user interface as previously described.

The available telephony upgrade credit may be a credit total as increased per specified time period. Next, the user determines whether to redeem the telephony upgrade credits (step 404). The user may make the decision based on factors, such as available redemption services, user needs, credit cost of a specified redemption service, available upgrade credit, service plan, or other information. The determination of step 404 may be a personal, business, or organization decision made based on the goals, needs, and wants of the user.

If the user determines not to redeem the telephony upgrade credit, the process terminates. If the user determines to redeem the telephony upgrade credits in step 404, the user selects a device, service, or feature (step 406). The user may select the redemption service of step 404 from a list of categories or applicable upgrades. In one embodiment, only devices, services, and features applicable to the user may be listed as available redemption services. For example, the user may select a communications-enabled media device in step 406 from a website of the communications service provider. In order for the redemption service to be purchased, the selected redemption service may require authorization, activation, or installation by the communications service provider to ensure availability and implementation with the services, structures, and protocols of the communication network.

Next, the user purchases the selection with the available telephony upgrade credit and/or user funds (step 408) with the process terminating thereafter. If the available telephony upgrade credit is insufficient to purchase the redemption service, the user may be required to pay a portion of the cost of the redemption service. However, the option to mix credits and user funds may provide the user more flexibility and increased satisfaction with the communications service provider.

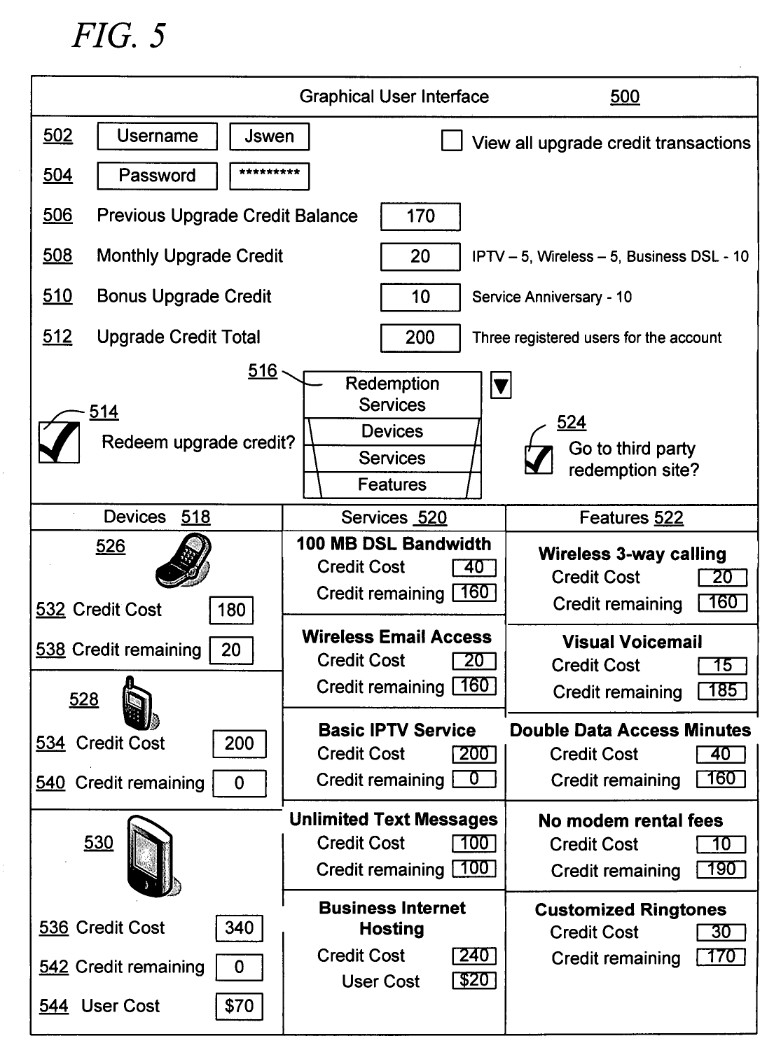

FIG. 5 is a graphical user interface for telephony upgrade credits in accordance with an illustrative embodiment. The graphical user interface (GUI) 500 may be displayed to a user in any number of ways. In one embodiment, the GUI 500 may be viewed from a website of a communications service provider as a webpage. In another embodiment, the GUI 500 may be displayed in an email or text message. Alternatively, a hard copy of the GUI 500 may be printed and mailed to the user as a bill, invoice, statement, or other account information.

The GUI 500 may display a variety of information to the user. In addition, the GUI 500 may include interactive components for receiving user input. The features shown in the GUI 500 are one illustrative example of details and features that may be displayed to the user and are shown only as an example. The GUI 500 may include a user name 502, password 504, previous upgrade credit balance 506, monthly upgrade credit 508, bonus upgrade credit 510, upgrade credit total 512, redeem upgrade credit indicator 514, category selection 516, device section 518, services section 520, features selection 522, third-party selection 524, communication devices 526, 528, and 530, credit cost 532, 534, 536, credit remaining 538, 540, and 542, and user cost 544. The GUI 500 may be linked to multiple accounts and service features of the communications service plan and may be one page of multiple account information pages available to the user.

The user name 502 and password 504 may be used to ensure that the user is authorized to view the content of the GUI 500, make account changes, and provide user input. In one embodiment, the user name 502 and password 504 may be used to establish a secure connection between a client device of the user and the billing system. The secure connection may be a virtual private network tunnel, an encrypted connection, firewall or other form of secured communication link suitable for securely exchanging data. The user name and password may be verified by an authentication device or module of the billing system.

The GUI 500 may display various telephony upgrade credit values or upgrade credits. In one embodiment, the GUI 500 displays a previous upgrade credit balance 506. The previous upgrade credit balance 506 may display the running balance for the accrued upgrade credits as of the previous billing statement or monthly invoice. The monthly upgrade credit 508 may show how many credits accrued for the specified time period. The monthly upgrade credit 508 may further detail credits received per service ordered, such as five credits for IPTV service, five credits for wireless services, and ten credits for business DSL. In this example, the time period is a month.

The bonus upgrade credit 510 may be a bonus credit given to the user. The bonus upgrade credit 510 may be a bonus or retention credit automatically or manually added to the user's account. In one example, a retention credit may be supplied as the bonus upgrade credit 510 in response to a customer service representative determining that the user may be experiencing some frustration with the current communications service plan or communication device in order to retain the user as a customer. The bonus upgrade credit 510 may also be provided for updating a communications service plan, completing a survey, referring a friend, continuous on-time payments, or other factors. The bonus upgrade credit 510 may also be a seasonal credit that is allotted each year or at specific dates. For example, the user may receive an additional credit in December or January for Christmas, Hanukah, or New Years Eve. In one example, the communications service provider may specify days or events for which the user receives additional bonus upgrade credits. In the given example, the bonus upgrade credit 510 may be received on the service anniversary or date the user first signed up for service with the communications service provider.

The upgrade credit total 512 may be the new total of the accumulated upgrade credits. As shown, the upgrade credit total 520 is the sum of the previous upgrade credit balance 506, monthly upgrade credit 508, and the bonus upgrade credit 510 if any are included. The upgrade credit total 512 may be the credits available to the user for redemption.

In one embodiment, the GUI 500 may allow a user to sort, filter, or otherwise view all upgrade credit transactions for the previous upgrade credit balance 506, monthly upgrade credit 508, bonus upgrade credit 510, and upgrade credit total 512.

The GUI 500 may include the redeem upgrade credit indicator 514. The redeem upgrade credit indicator 514 may be a button, icon, toggle, or other graphical interface for receiving a selection or user input from a user. As previously mentioned, the user may subscribe to any number of communications services which may include cellular service, paging, IPTV, VoIP, POTS, GMRS, WiFi, WiMax, data service, Internet hosting, or other communications services. As a result, once the redeem upgrade credit indicator is selected, the category selection 516 may be displayed in order to allow a user to select a category of redemption services. The category selection 516 may enable the GUI 500 or a program, instructions, or logic controlling the GUI 500 to display the device selection 518, services selection 520, and the features selection 522.

The different selections may display only devices, services, and features compatible with the user's preferences, location, and available resources. In one example, the devices selection 518 displays an assortment of wireless devices enabled for service in the user's area. The device selection 518 may also display set-top boxes, DVRs, routers, modems, and other hardware used by the user for communications services. For example, the communication devices 526, 528, and 530 may be available and compatible with the services and network of the communications service provider. The communication devices 526, 528, and 530 may be displayed to the user in terms of cost in credits and/or dollars as illustrated by credit costs 532, 534, and 536.

In some cases, the communication devices 526, 528, and 530 may cost more than the upgrade credit total 512. As a result, the GUI 500 may display credits remaining 538, 540, and 542 for each communication device 526, 528, and 530, as well as user cost 544 for displayed communication devices for which the credit cost 536 exceeds the upgrade credit total 512. As shown, if the user selects to redeem the upgrade credit total to purchase the communication device 530, the user cost 544 may be required because the credit cost 536 exceeds the upgrades credit total 512.

The information displayed by the GUI 500 may encourage a user to remain with a communications service provider by providing incentives and valuable information. In particular, the credit costs 532, 534, and 536, credits remaining 538, 540, and 542, and user cost 544 may allow a user to view and see how the upgrade credit total 512 is increasing and may be used.

The GUI 500 may include multiple types, screens, and pages of communication devices 526, 528, and 530. In one embodiment, the communication devices 526, 528, and 530 may be linked with additional features, services, and plans. For example, if the user selects to redeem the upgrade credit total 512 to purchase the communication device 528, the user may be required to upgrade to a special plan for text messaging or an increased bundle of anytime use calling minutes under the services selection 520 and the features selection 522.

The services selection 520 and features selection 522 similarly display services and features that the user may order, purchase, or use to expand already purchased services which may include a credit cost, credit remaining, or a user cost as previously described. For example, the services section 520 may list any number of wireless or wireline services or expanded services available to the user. The features selection 522 similarly lists features that the user may add. In one embodiment, the services and features of the services selection 520 and features selection 522 may be added or expanded for a specified time period or trial period. In one example, the user may have access to the services or features for one month in order to have sufficient time to use and learn the new services and features. At the end of the time period, the user is more likely to expand services based on the free trial of the services and features provided by redeeming all or a portion of the upgrade credit total 512. Some common services and features may include, but are not limited to, expanded IPTV or regular television programming, free on-demand access, premium movie packages, expanded calling features, increased wireless and wireline bandwidth, email service, ringtone availability, voicemail, more wireless or long distance minutes, increased text, video, or picture messaging, enhanced data services, Internet hosting, and credits and rebates. In another embodiment, entire pages or intranet sections may be dedicated to the device selection 518, services selection 520, the features selection, and third party selection 524.

In the event the user would prefer to redeem the upgrade credit total, the GUI 500 may include a third party selection 524. The third-party selection 524 may be an internal or external link to third party rewards. The third-party rewards may similarly include devices, services, or features manufactured, provided, or available from third parties that may have redemption agreements with the communications service provider. In one embodiment, the telephony credits may be increased or more valuable when redeemed for devices, services, or features of the communications service provider.

As a result, the GUI 500 may be used to offer expanded services and features to users in order to retain users and expand revenue generation.

The previous detailed description is of a small number of embodiments for implementing the invention and is not intended to be limiting in scope. The following claims set forth a number of the embodiments of the invention disclosed with greater particularity.

What is claimed:

1. A method for a feature credit, said method comprising:
determining a feature credit for a user in response to one or more telephony services being utilized by the user, and
adjusting a feature credit balance in response to determining the feature credit
redeeming the feature credit based on user input to provide the user a redemption service.

2. The method according to claim 1, wherein the feature credit balance is adjusted periodically based on a time period.

3. The method according to claim 1, further comprising:
displaying the feature credit and the feature credit balance to the user, wherein the displaying occurs on a monthly billing statement.

4. The method according to claim 1, wherein the redemption service includes devices, services, and features.

5. The method according to claim 1, wherein the determining occurs based on a value of the user related to the revenue received from the user.

6. The method according to claim 5, wherein the feature credit is a percentage of the revenue.

7. The method according to claim 1, wherein the revenue is classified into one of a plurality of levels and a value of the feature credit corresponds to the one of the plurality of levels.

8. The method according to claim 1, further comprising:
adding a bonus credit or a retention credit to the feature credit balance in response to competitive pressure from another communications service provider.

9. The method according to claim 1, wherein the feature credit is increased based on user usage of a communications service below a specified threshold.

10. The method according to claim 1, wherein the feature credit may be redeemed for any of ring tones, communications services, communication features, communication devices, rebates, and discounts.

11. The method according to claim 8, wherein the bonus credit is received for referring another user to one of a plurality of communications services.

12. The method according to claim 1, wherein the redemption service is received for a specified time period.

13. The method according to claim 1, wherein the redemption services include Internet Protocol television (IPTV), data, wireless, Voice over Internet Protocol, and voice services.

14. The method according to claim 1, wherein the redemption services include third-party services.

15. A billing system, said system comprising:
a server configured to determine a telephony upgrade credit issued to a user in response to an elapsed period of service;
a database in communication with the server, the database configured to store the telephony upgrade credit for access by the server; and
wherein the server further receives user input from a user through a graphical user interface to redeem the telephony upgrade credit for devices, services, or features available through a communication network.

16. The system according to claim 15, wherein the server includes records the telephony upgrade credit, determines the value of a user based on revenue received from the user for one or more communications services, sums the telephony upgrade credit, and receives input regarding a bonus credit or a retention credit.

17. The system according to claim 15, further comprising:
a purchasing system for redeeming the telephony upgrade credit for a specified time period, to any of purchase a communication device, upgrade a communication feature, upgrade a communications service, receive a discount, and receive a rebate.

18. The system according to claim 15, wherein the server is configured to generate the telephony upgrade credit based on user usage of a communications service below a specified threshold.

19. A billing system comprising:
a processor for executing a set of instructions;
a memory configured to store the set of instructions, wherein the set of instructions determines a new telephony upgrade credit to issue to a user in response to an elapsed period of service, sums the new telephony upgrade credit with a balance of a preexisting telephony upgrade credit to generate a total, displays the new telephony upgrade credit and the total to the user, and receives user input for redeeming the total to receive redemption services for a specified time period.

20. The billing system according to claim 19, wherein the set of instructions are configured to generate the new telephony upgrade credit based on user usage of a communications service below a specified threshold.

21. The billing system according to claim 19, wherein the set of instructions further determines a value of the user for determining the telephony upgrade credit based on revenue received from the user, wherein the new telephony upgrade credit is a percentage of the revenue.

22. The billing system according to claim 19, wherein an administrator with access to the billing system may transfer all or a portion of the total between a plurality of users to be redeemed by a specified user.
